(19) United States
(12) Patent Application Publication
(10) Pub. No.: US 2014/0265309 A1
(43) Pub. Date: Sep. 18, 2014

(54) EMT CONNECTOR AND METHODS FOR MAKING AND USING THE SAME

(71) Applicant: Sigma Electric Manufacturing Corporation, Garner, NC (US)

(72) Inventors: Ashok Alilughatta Sathyanarayana, Pune (IN); Vinayak Manohar Chavan, Pune (IN); Anand Chandrakant Dhotre, Pune (IN)

(73) Assignee: Sigma Electric Manufacturing Corporation, Garner, NC (US)

(21) Appl. No.: 14/206,027

(22) Filed: Mar. 12, 2014

Related U.S. Application Data
(60) Provisional application No. 61/780,237, filed on Mar. 13, 2013.

(51) Int. Cl. H02G 3/06

(52) U.S. Cl. CPC H02G 3/0633
USPC 285/154.1; 29/428; 29/426.2

(57) ABSTRACT

A connector 1 comprises a connector body 2 comprising an inlet end 16 and an outlet end 14 and a bore 7 extending therethrough; a threaded portion 3 on the outlet end 14; a flange 10 circumscribing the threaded portion 3; a spring 23 located in the connector body 2, wherein the spring 23 comprises a first spring portion 33 and a second spring portion 43, and an angle θ located therebetween, wherein the first spring portion 33 is located adjacent to a first connector body edge 4; and a locking device 24 located adjacent to the second spring portion 43, wherein the locking device 24 comprises a locking edge 34 and a leading edge 44, wherein the locking device 24 attaches to a portion of electrical metallic tubing 18 when tubing is inserted into the inlet end 16 of the connector body 2.

### CROSS-REFERENCE TO RELATED APPLICATION

This application claims the benefit of U.S. Provisional Patent Application Ser. No. 61/780,237 filed Mar. 13, 2013. The related application is incorporated herein by reference.

### TECHNICAL FIELD

The instant application relates to electrical metallic tubing connectors that can be easily installed in a junction box and that can be easily removed from a junction box.

### BACKGROUND

Electrical metallic tubing (EMT) is typically connected to electrical boxes (i.e., junction boxes) by a tubular fitting including a threaded end with a threaded nose for insertion into a circular aperture in a box and a leading end including a screw mounted laterally through the fitting wall for securing the electrical metallic tubing to the fitting. This arrangement, although providing satisfactory tubing retention and sufficient electrical continuity between the electrical metallic tubing to the electrical box, junction, and various electrical housings to satisfy electrical code requirements, is time consuming and labor intensive. For every connection, an installer must first stab the threaded end of the fitting into the box and thread a lock nut onto the threaded nose to secure the fitting to the box and, secondly, secure the electrical metallic tubing to the leading end of the fitting by tightening the laterally mounted screw through the fitting wall. For any given installation of electrical metallic tubing in a building or factory, there can be hundreds or even thousands of such connections needed to completely wire the building. Additionally, tools must typically be used to achieve a secure connection, including a wrench on the lock nut and a screwdriver on the laterally mounted screw. Therefore, it should be appreciated that completing all of these connections can be very time consuming, requiring at least two different tools in order to complete each connection. Furthermore, when removing or replacing electrical metallic tubing connectors, an equal amount of time is needed to remove and tool(s) are often required to complete removal.

Electrical metallic tubing is generally held in place once in the junction box with tangs extending from a retaining ring as part of the tubular fitting. The tangs dig into the outer surface of the electrical metallic tubing. While this serves to hold the tubing in place, if a change or modification is required, such that the tubing needs to be removed from the connector and/or junction box, it often cannot be completed without cutting the tubing or completely disassembling the fitting. Such a process can be difficult and time consuming and can make any subsequent modifications to the configuration of the tubing difficult.

Thus, an electrical metallic tubing connector that can easily be installed and/or removed from a junction box is therefore desirable.

### BRIEF DESCRIPTION

Disclosed herein are electrical metallic tubing connectors and methods for making and using the electrical metallic tubing connectors.

In an embodiment, a connector 1 comprises a connector body 2 comprising an inlet end 16 and an outlet end 14 and a bore 7 extending therethrough; a threaded portion 3 on the outlet end 14; a flange 10 circumscribing the threaded portion 3; a spring 23 located in the connector body 2, wherein the spring 23 comprises a first spring portion 33 and a second spring portion 43, and an angle θ located therebetween, wherein the first spring portion 33 is located adjacent to a first connector body edge 4; and a locking device 24 located adjacent to the second spring portion 43, wherein the locking device 24 comprises a locking edge 34 and a leading edge 44, wherein the locking device 24 attaches to a portion of electrical metallic tubing 18 when tubing is inserted into the inlet end 16 of the connector body 2.

In another embodiment, a dual-sided connector 100, comprises a connector body 200 comprising a first conduit 102 and a second conduit 104 wherein the first conduit 102 and the second conduit 104 comprise an inlet end 16 and a bore 7 extending therethrough; a spring 23 in the first conduit 102 and in the second conduit 104, wherein the spring 23 comprises a first spring portion 33 and a second spring portion 43, and an angle θ located therebetween, wherein the first spring portion 33 is located adjacent to a first connector body edge 4; and a locking device 24 in the first conduit 102 and in the second conduit 104, wherein the locking device 24 is located adjacent to the second spring portion 43, wherein the locking device 24 comprises a locking edge 34 and a leading edge 44, wherein the angle θ decreases when electrical metallic tubing 18 is inserted into the inlet end 16 of the connector body 200.

In another embodiment, a method of making a connector 1, comprises forming a connector body 2 comprising an inlet end 16 and an outlet end 14, and a bore 7 extending therethrough; forming a threaded portion 3 on the outlet end 14; forming a flange 10 circumscribing the threaded portion 3; inserting a spring 23 in the connector body 2 in an opening 6, wherein the spring 23 comprises a first spring portion 33 and a second spring portion 43, and an angle θ located therebetween, wherein the first spring portion 33 is located adjacent to a first connector body edge 4; and inserting a locking device 24, located adjacent to the second spring portion 43, into the connector body 2 through the opening 6, wherein the locking device 24 comprises a locking edge 34 and a leading edge 44.

These and other features of the electrical metallic tubing connector and methods of making will be understood from the drawings and description below.

### BRIEF DESCRIPTION OF THE DRAWINGS

Refer now to the figures, which are exemplary embodiments, and wherein the like elements are numbered alike, and are not necessarily re-described in relation to each figure.

FIG. 1 is an illustration of an exterior view of a connector.

FIG. 2 is an illustration of a cross-sectional view of the connector of FIG. 1.

FIG. 3 is an illustration of an exterior view of a connector body.

FIG. 4 is an illustration of a cross-sectional view of the connector body of FIG. 3.

FIG. 5 is an isometric view of the connector body of FIG. 3.

FIG. 6 is another isometric view of the connector body of FIG. 3.

FIG. 7 is an assembled view of the electrical metallic tubing snap-lock connector of FIG. 1.

FIGS. 8-14 are illustrations of an electrical metalling tubing being inserted and removed from a connector.

FIG. 15 is an illustration of an exterior view of a coupled connector.

FIG. 16 is an illustration of a cross-sectional view of the coupled connector of FIG. 15.

FIG. 17 is an illustration of an exterior view of a coupled connector body.

FIG. 18 is an illustration of a cross-sectional view of the coupled connector body of FIG. 17.

FIG. 19 is an isometric view of the connector body of FIG. 17.

FIG. 20 is another isometric view of the connector body of FIG. 17.

FIG. 21 is an illustration of an assembled coupled connector.

FIG. 22 is an illustration of a snap fitting cap on a connector.

FIG. 23 is an exploded view of the snap fitting cap of FIG. 22.

FIG. 24 is an illustration of a snap fitting cap on a connector.

FIG. 25 is an exploded view of the snap fitting cap of FIG. 24.

### DETAILED DESCRIPTION

Disclosed herein are electrical metallic tubing connectors (also referred to herein as electrical metallic tubing snap-lock connectors, snap-lock electrical connectors, or connectors) comprising electrical metallic tubing that can be easily and quickly assembled to and removed from a connector and/or a junction box. For example, the electrical metallic tubing connectors disclosed herein can allow installation and removal of the electrical metallic tubing from a connector without an additional tool. The electrical metallic tubing connector can then be attached to a junction box with or without the use of an additional tool. The electrical metallic tubing connectors (also referred to herein as “the connector”) disclosed herein can allow insertion of electrical metallic tubing (e.g., pipes) into a connector body, for example, with a pushing motion or force from the user's hand to glide the electrical metallic tubing into the connector. The connectors can have an inlet end, where the electrical metallic tubing can be inserted and an outlet end, where the connector can attach to an electrical box. The connector body can comprise a unitary connector body, meaning that the connector body is a single piece component (e.g., a die cast component).

A leading edge on a locking device of the connector body can be pushed upward and toward an outlet end of the connector when electrical metallic tubing is inserted into the connector body such that a locking edge can engage the electrical metallic tubing once it has been inserted into the connector body past the leading edge and the locking edge. Force from a spring located adjacent to the locking device can exert pressure on the locking device such that the locking edge can hold the electrical metallic tubing inside the connector body. The connector body with the electrical metallic tubing installed can then be inserted into a junction box, for example, by means of a locknut. The locking device can resist an opposing or pulling force, which can be imparted on the tube to prohibit separation of the electrical metallic tubing from the connector body.

Removal of the electrical metallic tubing from the connector body can be effected by applying force to an optional cam (e.g., an unlock position) that protrudes from an inlet end of the connector body. The applied force can release the pressure from the spring holding the locking device in place such that the locking edge is moved upward to release the electrical metallic tubing so that it can be removed from the connector body. The force on the cam can be removed once the electrical metallic tubing has been released from the body. The electrical metallic tubing can then be reused if desired. Likewise, when a cam is not present, an opening can be present such that a tool can be inserted into said opening to apply a force to release the pressure from the spring holding the locking device such that the electrical metallic tubing can be removed.

The connector body can have a threaded end (i.e., outlet end or junction box end) for engagement with an electric box or panel and can have an inlet end allowing insertion of electrical metallic tubing therein. The connector body can also comprise a dual-sided (often referred to as a “coupling”) electrical metallic tubing connector such that the connector acts to connect two different conduits or electrical metallic tubings to one another. For example, a dual-sided electrical metallic tubing connector can couple two electrical metallic tubings together so that an inlet end is present on either end of the connector.

The connector body can further comprise an optional cap configured to protect the tubing from outside elements such as rain, snow, debris, etc. The cap can be connected to the connector body by a snap fit mechanism, a hinge (e.g., with a pin opening), a screw, etc., and combinations comprising at least one of the foregoing.

The various components of the connector can comprise any material that will provide the desired structural integrity and protection to the internal components of the connector. For example, the connector body, cap, cam, spring, and locking device can comprise the same or different materials, wherein the materials can comprise a metal (e.g., a metal die cast part) such as zinc (e.g., a zinc die cast part), aluminum (e.g., aluminum die cast part), or steel (e.g., a zinc die cast part), plastic materials, including thermoplastic and thermoset materials, or combinations comprising at least one of the foregoing. The connector body can comprise a single piece die cast part.

Referring now to the figures, which are exemplary and not intended to limit the scope hereof A more complete understanding of the components, processes, and apparatuses disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

Referring to FIGS. 1 to 7, FIGS. 1 and 2 illustrate an electrical metallic tubing connector 1 (also referred to herein as “the connector”) for attaching a conduit or an electrical metallic tubing to an electric box or panel (not shown), wherein the connector 1 can comprise a connector body 2 having a generally cylindrical shape that can allow insertion of electrical metallic tubing therein. FIGS. 3 and 4 illustrate the connector body 2 in more detail. The connector 1 can further comprise an optional cap 21 for enabling the connector 1 to be concrete tight and/or weatherproof (e.g., the cap can secure the electrical metallic tubing against rain, snow, ice, debris, etc., and damage resulting therefrom if those elements are allowed to enter the connector). The cap 21 can be located such that it covers an opening 6 of the connector body 2 and a portion of an optional cam 22 (FIG. 2) protruding from an inlet end 16 of the connector 1.

The cap 21 can be connected to the connector body 2 by any mechanism that will provide a secure connection between the cap 21 and the connector body 2. For example, the cap 21 can be connected to the connector body 2 by a snap fit, a hinge fit (e.g., with a pin), with a screw, with adhesive, or any other mechanism that will provide a secure connection. Examples of snap fit connectors are illustrated in FIGS. 22 and 23, where FIG. 23 is an exploded view of the snap fit of FIG. 22. FIGS. 22 and 23 illustrate a cap 21 that has a cap lock 71 that locks onto a locking edge 72 that is part of the connector body 2. The cap lock 71 can span the length, L, of the cap or the cap can comprise one or more cap locks 71, e.g., a plurality of the cap lock 71 can be located along the length L of the cap. For example, cap lock 71 can be located on one or both sides of a raised body portion 78 such that a first cap lock 71 is located proximal to a cap first end 73 and a second cap lock 71 is located proximal to a cap second end 74. It is noted that the cap 21 is illustrated in FIGS. 22 and 23 without the cap lip 77 (see FIGS. 24 and 25). The cap 21 is illustrated without the cap lip 77 in order to facilitate viewing of the above-described snap fit. These snap fits can be used with any of the embodiments disclosed herein and are not limited to the specific designs illustrated in FIGS. 22 to 25.

Another example of a snap fit is illustrated in FIGS. 24 and 25, where FIG. 25 is an exploded view of the snap fit of FIG. 24. FIGS. 24 and 25 illustrate a body lock 76 that locks into a cap opening 75 that is located in the cap 21. The cap 21 can comprise one or more body lock 76 and cap openings 75, for example, a body lock 76 and cap opening 75 can be located on one or both sides of a raised body portion 78. The cap 21 as illustrated in FIGS. 22 and 24 can have a mirror symmetry whose axis is along the length, L, of the raised portion 31. It is noted that while the snap fit is illustrated on a single sided connector, one skilled in the art can readily envision a dual side connector with two caps, where the two caps may or may not be connected in the same manner, for example, one cap can be connected via the snap fit as illustrated in FIGS. 24 and 25 and the second cap can be adhesively attached. It is also noted that one side of the cap can be connected via the above-mentioned snap fit, while the other side can be connected to the connector via a hinge.

The connector body 2 can comprise an inlet end 16 for insertion of the electrical metallic tubing and an outlet end (e.g., box end) 14 for attachment to the electric box. An attachment device 20 (e.g., a lock nut) can be used to attach the connector 1 to an electrical box. For example, the outlet end 14 of the connector body 2 can comprise a threaded portion 3, which can engage the attachment device 20 and can allow the connector body 2 to attach to and remain attached to the electrical box. Circumscribing the connector body 2 exteriorly thereof at the outlet end 14 can be a radially outwardly extending flange 10, which can function as a stop to effectively limit the distance the connector body 2 can be inserted through a knockout hole of an electrical box or panel. The attachment device 20 can, optionally, comprise teeth 26 that can engage a wall of the electric box to provide a secure connection between the connector 1 and the electric box. The threaded portion 3 of the outlet end 14 can allow the attachment device 20 to be inserted thereon after inserting the connector body 2 into the electrical box. The attachment device 20 can be rotated on the threaded portion 3 of the connector body 2 to secure the connector 1 to the electrical box.

As illustrated in FIGS. 3 and 4, the connector body 2 can have a bore 7 therethrough that can receive a conduit or electrical metallic tubing through inlet end 16 of the connector body 2. The bore 7 can have the same or a varying diameter with, for example, a diameter D₁ in the region of the threaded portion 3 and a diameter D₂ through the remaining portion of the connector body 2, where D₂ can be greater than D₁. An optional shoulder 11 thereof can be formed, which, if present, can act as a stop to limit the distance a conduit or electrical metallic tubing can be inserted therein.

FIG. 5 further illustrates the connector body 2. For example, as demonstrated in FIG. 5, the connector body 2 can additionally comprise a ledge 8 protruding from a surface of the connector body opposite the surface which the optional cap 21 attaches. Ribs 12 can extend in either or both directions of the ledge 8 to provide additional structural integrity to the connector body 2. FIG. 6 illustrates the surface of the connector body 2 to which the optional cap 21 attaches when present. As illustrated in FIG. 6, the connector body 2 can comprise a depression 28 with raised sides into which a portion of the cam 22 can rest when present. Likewise, when a cam is not present, the depression 28 with raised sides can form part of an opening into which a tool can be inserted to facilitate removal of the electrical metallic tubing. An indentation 30 can be located opposite the depression 28 into which a portion of the cap 21 can fit over (e.g., can snap into the depression 28).

FIGS. 2, 3, and 4 further illustrate various features of the connector 1. For example, as illustrated in FIG. 2 the connector 1 can comprise a spring 23 and a locking device 24, both located in the connector body 2. As illustrated in FIGS. 2 and 4, the connector body 2 can have a recess 25 and an opening 6 (FIG. 4) that can allow insertion of the spring 23 and the locking device 24. The spring 23 and/or locking device 24 can be located in the connector body 2 such that at least a portion of the spring 23 and/or locking device 24 are located in the recess 25. The spring can comprise a first spring portion 33 and a second spring portion 43, wherein the second spring portion 43 can be at an angle θ relative to the first spring portion 33 (e.g., the first spring portion 33 can be perpendicular and the second spring portion 43 can be angled). For example, the first spring portion 33 can be parallel to a first connector body edge 4 and the second spring portion 43 can be parallel to a second connector body edge 5 when the connector is free of an electrical metallic tubing. It will be understood that the edges disclosed herein do not have to be exactly parallel for the spring to function in the connector and that other variations on the spring can be made provided that the spring exerts a force on the locking device as described herein.

The first spring portion 33 can be adjacent to, or even, in physical contact with the first connector body edge 4. An inner spring diameter Dₛ can be greater than the diameter D₂ such that the spring 23 does not contact the inserted conduit or electrical metallic tubing. Likewise, the inner edge of the first spring portion 33 can be in physical contact with the electrical metallic tubing provided it does not obstruct the insertion path of said tubing. The first spring portion 33 can be held in place such that a portion of the first spring portion 33 is locked into at least one slot 70. The second spring portion 43 can be adjacent to (e.g., in physical contact) the locking device 24. A portion of the spring 23 can provide for an interlocking connection 53 with the locking device 24 such that the relative position of the two remains the same (see FIG. 2). Likewise, the spring 23 and the locking device 24 can be free of an interlocking connection 53. The locking device 24 can act as a unidirectional lock when engaged in the locked position such that a locking edge 34 applies a pressure to the conduit or electrical metallic tubing and therefore can resist an opposing or pulling force which can be imparted on the tube to prohibit separation.

The connector 1 can further comprise a cam 22 located on the connector body 2. The cam 22 can be located such that a cam inner edge 32 can be adjacent to (e.g., in physical contact with) a locking corner 54 of the locking device 24. As illustrated in FIG. 2, a portion of the cam 22 can be located within a raised portion 31 of the cap 21. FIG. 7 illustrates an assembled view of the connector 1 where the optional cap 21 can be attached to the connector body 2 with an optional cam 22 resting in the depression 28 with the raised portion 31 of the cap 21 covering a portion of the cam 22 and fitted over the indentation 30.

Turning now to FIGS. 8 to 14, the installation and removal processes of the electrical metallic tubing are illustrated where FIGS. 8 to 11 illustrate installation and FIGS. 12 to 14 illustrate removal. In FIG. 8, the spring 23 can be seen as applying force on the locking device 24 before insertion of the electric metallic tubing 18 such that the locking device 24 is angled compared to the first spring portion 33 as previously described. The locking device 24 has a pivot point 64 about which the locking device moves when electrical metallic tubing 18 is inserted into the connector 1. In FIG. 9, the electrical metallic tubing 18 has been partially inserted into the connector 1 at the inlet end 16 and a pushing force from the electrical metallic tubing 18 is applied to the locking device 24. Once the electrical metallic tubing 18 has been inserted into the connector 1 and touches the leading edge 44 of the locking device 24, the locking device 24 can begin to tilt toward the outlet end 14 with respect to the pivot point 64, as illustrated in FIG. 10.

Upon further insertion of the electrical metallic tubing 18 into the connector 1, the locking device can tilt further in an upward direction toward the first spring portion 33 such that the angle θ between the first spring portion 33 and the second spring portion 43 is decreased, thereby resulting in compression of the spring 23. For example, the electrical metallic tubing 18 can push past the leading edge 44 of the locking device 24 and engage the locking edge 34 of the locking device such that an internal diameter of the locking device 24 can become concentric to the electrical metallic tubing diameter thereby allowing the electrical metallic tubing to extend past the locking edge 34 of the locking device 24 and further into the connector 1. FIG. 11 illustrates electrical metallic tubing 18 that has been completely inserted into the connector 1 and is in a locked position due to the electrical metallic tubing 18 engaging with the locking edge 34 of the locking device 24. In this position, the spring 23 can apply force on the locking device 24 and the locking device 24 can apply force on the electrical metallic tubing 18 to hold the electrical metallic tubing 18 in position inside the connector 1.

Turning now to FIGS. 12 to 14, removal of electrical metallic tubing 18 from the connector 1 is illustrated. As illustrated in FIG. 12, when in the locked position (e.g., when the electrical metallic tubing 18 has been inserted completely into the connector 1 and is engaged with the locking device 24), greater than or equal to 50%, specifically, greater than or equal to 75%, more specifically, greater than or equal to 90% of the cam inner edge 32 can be in physical contact with the leading edge 44 of the locking device 24. To remove the electrical metallic tubing 18 from the connector 1, a force (e.g., a push force) can be applied to the cam 22 in the direction of the locking device 24 so that the locking edge 34 of the locking device 24 can be removed from engagement with the electrical metallic tubing 18. When a force is applied to the cam 22 on the cam outer edge 42 in the direction of the locking device 24, the locking edge 34 of the locking device 24 can move upward, thereby releasing the locking edge 34 from the electrical metallic tubing 18 so that the electrical metallic tubing 18 can move toward the inlet end 16 of the connector 1. Once the electrical metallic tubing 18 has been released from engagement with the locking edge 34 of the locking device 24, the force on the cam 22 can be removed. In FIG. 14, the electrical metallic tubing 18 has been completely removed from the connector 1 and the locking device 24 is in an open, unlocked position. When the cam 22 is pushed in, the connector 1 is generally in the unlocked position and the conduit or electrical metallic tubing can be easily removed and/or inserted from the connector 1, though the cam 22 does not need to be pushed in for insertion of the conduit or electrical metallic tubing. When the force on the cam outer edge 42 is released, the spring 23 can exert a force on the locking device 24 that can push the cam 22 back toward the inlet end 16. It is to be understood that the electrical metallic tubing 18 can also be released from the locking edge 34 of the locking device 24 by any means, such as by inserting a pin through an opening such as opening 6 to apply a force on the locking device 24.

FIGS. 15 to 21 illustrate a dual-sided (often referred to as a “coupling”) electrical metallic tubing snap-lock, dual sided connector 100 (also referred to herein as “dual-sided connector”), e.g., a coupled connector. The dual side connector 100 can connect two different conduits or electrical metallic tubings to one another. For example, as illustrated in FIGS. 15 and 16, the dual-sided connector 100 can comprise a dual-sided connector body 200 having a first conduit 102 and a second conduit 104 and an inlet end 16 on each of the first conduit 102 and the second conduit 104. The dual-sided connector 100 can also comprise an optional cap 21 on each of the first conduit 102 and the second conduit 104 and an optional cam 22 protruding from each inlet end 16 of the dual-sided connector 100. FIG. 16 illustrates the internal components of the dual-sided connector 100 and the dual-side connector body 200. For example, as shown in FIG. 16, the dual-sided connector body 200 can further comprise a spring 23 and a locking device 24 in each of the first conduit 102 and the second conduit 104.

The first conduit 102 and the second conduit 104 can be mirror images of one another and can therefore have the same inner and outer diameters. It is also contemplated that the first conduit 102 and the second conduit 104 can have different inner and outer diameters. The dual-sided connector body can further have a bore 7 extending therethrough (i.e., extending from inlet end 16 through the first conduit 102, the second conduit 104, and inlet end 160) with a protrusion 106 located between the first conduit 102 and the second conduit 104 so that tubing inserted into the first conduit 102 does not extend into the second conduit 104 and vice versa. The diameter of the protrusion 106, D₃, can be less than the diameter of the bore 7 in either of the first conduit 102 having a diameter, D₄, or a second conduit 104 having a diameter, D₅ (FIG. 18), where D₄ and D₅ can be greater than D₃ and where D₄ and D₅ can be the same or different.

As illustrated in FIGS. 16 and 17, the connector body 200 can have a recess 25 and an opening 6 (FIG. 17) in each of the first conduit 102 and the second conduit 104 that can allow insertion of the spring 23 and the locking device 24. The spring 23 and/or locking device 24 can be located in the connector body 200 in the first conduit 102 and in the second conduit 104 such that at least a portion of the spring 23 and/or locking device 24 are located in the recess 25. The spring 23 can comprise a first spring portion 33 and a second spring portion 43, wherein the second spring portion 43 can be at an angle θ relative to the first spring portion 33 (e.g., the first spring portion 33 can be perpendicular and the second spring portion 43 can be angled). For example, the first spring portion 33 can be parallel to a first connector body edge 4 and the second spring portion 43 can be parallel to a second connector body edge 5 when the connector is free of electrical metallic tubing. It will be understood that the edges disclosed herein do not have to be exactly parallel for the spring to function in the connector and that other variations on the spring can be made provided that the spring exerts a force on the locking device as described herein.

The first spring portion 33 can be adjacent to, or even, in physical contact with the first connector body edge 4. An inner spring diameter Dₛ can be greater than the diameter D₂ such that the spring 23 does not contact the inserted conduit or electrical metallic tubing. Likewise, the inner edge of the first spring portion 33 can be in physical contact with the electrical metallic tubing provided it does not obstruct the insertion path of said tubing. The first spring portion 33 can be held in place such that a portion of the first spring portion 33 is locked into at least one slot 70. The second spring portion 43 can be adjacent to (e.g., in physical contact) with the locking device 24. A portion of the spring 23 can provide for an interlocking connection 53 with the locking device 24 such that the relative position of the two remains the same (see FIG. 16). Likewise, the spring 23 and the locking device 24 can be free of an interlocking connection 53. The locking device 24 can act as a unidirectional lock when engaged in the locked position such that a locking edge 34 applies a pressure to the conduit or electrical metallic tubing and therefore can resist an opposing or pulling force which can be imparted on the tube to prohibit separation. The dual sided connector 100 can further comprise an optional cam 22 located on one or both of the first conduit 102 and the second conduit 104 of the connector body 200. The cam 22 can be located such that a cam inner edge 32 can be adjacent to (e.g., in physical contact) with a locking corner 54 of the locking device 24. As illustrated in FIG. 16, a portion of the cam 22 can be located within a raised portion 31 of the cap 21.

FIG. 19 further illustrates the connector body 200. For example, as demonstrated in FIG. 19, the connector body 200 can additionally comprise a ledge 8 protruding from a surface of the connector body opposite the surface which the optional cap 21 attaches on each of the first conduit 102 and the second conduit 104. Ribs 12 can extend in either or both directions of the ledge 8 to provide additional structural integrity to the connector body 2. FIG. 20 illustrates the surface of the connector body 200 to which the cap 21 attaches when present. As illustrated in FIG. 20, the connector body 200 can comprise a depression 28 with raised sides into which a portion of the cam 22 can rest when present (FIG. 21). Likewise, when a cam is not present, the depression 28 with raised sides can form part of an opening into which a tool can be inserted to facilitate removal of the electrical metallic tubing. An indentation 30 can be located opposite the depression 28 into which a portion of the cap 21 can fit over (e.g., can snap into the depression 28). FIG. 21 illustrates an assembled dual-sided connector 100 with optional caps 21 attached to each of the first conduit 102 and the second conduit 104, with optional cams 22 resting in depressions 28. The raised portion 31 of the caps 21 covers a portion of the cams 22.

A conduit or electrical metallic tubing can be inserted and removed into either end of the dual-sided connector 100 in the same manner as described above for the connector 1 in FIGS. 1 to 14.

It is noted that the connector piece as herein described can be used to connect electrical metallic tubing of various sizes, including but not limited to ½ inch (12.7 millimeters (mm)), ¾ inch (19.1 mm), 1 inch (25.4 mm), etc. It is further contemplated that the connectors described herein can also be used to connect non-electrical tubes, such as plastic tubes and the like. It is also noted that while reference is made to connectors that can connect one or two conduits or electrical metallic tubings, embodiments wherein three or more conduits or tubes are connected are also envisioned.

Set forth below are some embodiments of connectors and methods of making connectors as disclosed herein.

### Embodiment 1

a connector comprising: a connector body 2 comprising an inlet end 16 and an outlet end 14 and a bore 7 extending therethrough; a threaded portion 3 on the outlet end 14; a flange 10 circumscribing the threaded portion 3; a spring 23 located in the connector body 2, wherein the spring 23 comprises a first spring portion 33 and a second spring portion 43, and an angle θ located therebetween, wherein the first spring portion 33 is located adjacent to a first connector body edge 4; and a locking device 24 located adjacent to the second spring portion 43. The locking device 24 comprises a locking edge 34 and a leading edge 44. The locking device 24 attaches to a portion of electrical metallic tubing 18 when tubing is inserted into the inlet end 16 of the connector body 2.

### Embodiment 2

the connector of Embodiment 1, further comprising an attachment device 20.

### Embodiment 3

the connector of any of Embodiments 1-2, further comprising a cap 21 on an opening 6 in the connector body 2.

### Embodiment 4

the connector of any of Embodiments 1-3, wherein the cap 21 is attached to the connector body 2 on an indentation 30 formed on the connector body 2 at the outlet end 14 and on a depression 28 on the inlet end 16.

### Embodiment 5

a connector, comprising: a connector body 200 comprising a first conduit 102 and a second conduit 104 wherein the first conduit 102 and the second conduit 104 comprise an inlet end 16 and a bore 7 extending therethrough; a spring 23 in the first conduit 102 and in the second conduit 104, wherein the spring 23 comprises a first spring portion 33 and a second spring portion 43, and an angle θ located therebetween, wherein the first spring portion 33 is located adjacent to a first connector body edge 4; and a locking device 24 in the first conduit 102 and in the second conduit 104. The locking device 24 is located adjacent to the second spring portion 43. The locking device 24 comprises a locking edge 34 and a leading edge 44. The angle θ decreases when electrical metallic tubing 18 is inserted into the inlet end 16 of the connector body 200. The connector is a dual sided connector.

### Embodiment 6

the connector of Embodiment 5, further comprising a cap 21 on an opening 6 in the first conduit 102 and/or the second conduit 104.

### Embodiment 7

the connector of any of Embodiments 5-6, wherein the cap 21 is attached to the first conduit 102 on an indentation 30 and a depression 28 formed on the first conduit 102 and/or wherein the cap 21 is attached to the second conduit 104 on an indentation 30 and a depression 28 formed on the second conduit 104.

### Embodiment 8

the connector of any of Embodiments 1-7, wherein the cap 21 comprises a raised portion 31.

### Embodiment 9

the connector of any of Embodiments 1-8, wherein the connector further comprises a cam 22 resting on the depression 28, wherein a cam inner edge 32 is adjacent the locking device 24.

### Embodiment 10

the connector of any of Embodiments 1-9, wherein the angle θ is decreased when tubing 18 is inserted into the inlet end 16 of the connector body 2, 200.

### Embodiment 11

the connector of any of Embodiments 1-10, wherein the locking device 24 attaches to a portion of tubing 18 when the tubing 18 is inserted into the inlet end 16 of the connector body 2, 200.

### Embodiment 12

a method of making a connector, comprising: forming a connector body 2 comprising an inlet end 16 and an outlet end 14 and a bore 7 extending therethrough; forming a threaded portion 3 on the outlet end 14; forming a flange 10 circumscribing the threaded portion 3; inserting a spring 23 in the connector body 2 in an opening 6, wherein the spring 23 comprises a first spring portion 33 and a second spring portion 43, and an angle θ located therebetween, wherein the first spring portion 33 is located adjacent to a first connector body edge 4; and inserting a locking device 24, located adjacent to the second spring portion 43, into the connector body 2 through the opening 6, wherein the locking device 24 comprises a locking edge 34 and a leading edge 44.

### Embodiment 13

the method of Embodiment 12, further comprising inserting an attachment device 20 onto the threaded portion 3.

### Embodiment 14

the method of any of Embodiments 12-13, further comprising attaching a cap 21 to the connector body 2, 200 over the opening 6.

### Embodiment 15

the method of any of Embodiments 12-14, wherein the cap 21 comprises a raised portion 31.

### Embodiment 16

the method of any of Embodiments 12-15, further comprising attaching the cap 21 to the connector body 2, 200 on an indentation 30 formed on the connector body 2, 200 at the outlet end 14 and on a depression 28 on the inlet end 16.

### Embodiment 17

the method of any of Embodiments 12-16, further comprising inserting a cam 22 into the depression 28, wherein a cam inner edge 32 is adjacent to the locking device 24.

### Embodiment 18

the method of any of Embodiments 12-17, further comprising inserting tubing 18 into the inlet end 16 of the connector body 2, 200, wherein the tubing 18 contacts the leading edge 44 of the locking device 24 and moves the locking device 24 toward the outlet end 14 decreasing the angle θ.

### Embodiment 19

the method of Embodiment 18, wherein the locking edge 34 of the locking device 24 engages with a portion of the tubing 18 to hold it within the connector 1.

### Embodiment 20

the method of any of Embodiments 18-19, further comprising pressing a cam outer edge 42 and releasing the tubing 18 from the locking edge 34 of the locking device 44.

The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements can be combined in any suitable manner in the various embodiments.

While particular embodiments have been described, alternatives, modifications, variations, improvements, and substantial equivalents that are or may be presently unforeseen may arise to Applicants or others skilled in the art. Accordingly, the appended claims as filed and as they may be amended are intended to embrace all such alternatives, modifications variations, improvements, and substantial equivalents.

What is claimed is:

1. A connector, comprising:
a connector body comprising an inlet end and an outlet end and a bore extending therethrough;
a threaded portion on the outlet end;
a flange circumscribing the threaded portion;
a spring located in the connector body, wherein the spring comprises a first spring portion and a second spring portion and an angle θ located therebetween, wherein the first spring portion is located adjacent to a first connector body edge; and
a locking device located adjacent to the second spring portion, wherein the locking device comprises a locking edge and a leading edge, wherein the locking device attaches to a portion of electrical metallic tubing when tubing is inserted into the inlet end 16 of the connector body.

2. The connector of claim 1, further comprising a cap on an opening in the connector body.

3. The connector of claim 2, wherein the cap is attached to the connector body on an indentation formed on the connector body at the outlet end and on a depression on the inlet end.

4. The connector of claim 2, wherein the cap is attached to the connector body with a snap fit connector.

5. The connector of claim 2, wherein the snap fit connector comprises a lock extending over an edge and/or into an opening.

6. The connector of claim 2, wherein the snap fit connector comprises a lock extending into an opening.

7. The connector of claim 1, wherein the connector 1 further comprises a cam resting on the depression, wherein a cam inner edge is adjacent to the locking device.

8. The connector of claim 1, wherein the angle θ is decreased when electrical metallic tubing is inserted into the inlet end of the connector body and is increased when electrical metallic tubing is removed from the inlet end of the connector body.

9. A dual-sided connector, comprising:
a connector body comprising a first conduit and a second conduit wherein the first conduit and the second conduit comprise an inlet end and a bore extending therethrough;
a spring in the first conduit and in the second conduit, wherein the spring comprises a first spring portion and a second spring portion and an angle θ located therebetween, wherein the first spring portion is located adjacent to a first connector body edge; and
a locking device in the first conduit and in the second conduit, wherein the locking device is located adjacent to the second spring portion, wherein the locking device comprises a locking edge and a leading edge, wherein the angle θ decreases when electrical metallic tubing is inserted into the inlet end of the connector body.

10. The dual-sided connector of claim 9, further comprising a cap on an opening in the first conduit and/or the second conduit.

11. The dual-sided connector of claim 9, wherein the cap is attached to the first conduit on an indentation and a depression formed on the first conduit and/or wherein the cap is attached to the second conduit on an indentation and a depression formed on the second conduit.

12. The dual-sided connector of claim 9, wherein the dual sided connector further comprises a cam resting on the depression, wherein a cam inner edge is adjacent to the locking device.

13. The dual-sided connector of claim 9, wherein the locking device attaches to a portion of electrical metallic tubing when the electrical metallic tubing is inserted into the inlet end of the connector body.

14. A method of making a connector, comprising:
forming a connector body comprising an inlet end and an outlet end and a bore extending therethrough;
forming a threaded portion on the outlet end;
forming a flange circumscribing the threaded portion;
inserting a spring in the connector body in an opening, wherein the spring comprises a first spring portion and a second spring portion, and an angle θ located therebetween, wherein the first spring portion is located adjacent to a first connector body edge; and
inserting a locking device, located adjacent to the second spring portion, into the connector body through the opening, wherein the locking device comprises a locking edge and a leading edge.

15. The method of claim 14, further comprising attaching a cap to the connector body over the opening.

16. The method of claim 15, further comprising attaching the cap to the connector body on an indentation formed on the connector body at the outlet end and on a depression on the inlet end.

17. The method of claim 14, further comprising inserting a cam into the depression, wherein a cam inner edge is adjacent to the locking device.

18. The method of claim 14, further comprising inserting electrical metallic tubing into the inlet end of the connector body, wherein the electrical metallic tubing contacts the leading edge of the locking device and moves the locking device toward the outlet end decreasing the angle θ.

19. The method of claim 18, wherein the locking edge of the locking device engages with a portion of the electrical metallic tubing to hold it within the connector.

20. The method of claim 14, further comprising pressing a cam outer edge and releasing the electrical metallic tubing from the locking edge of the locking device.
